(19) United States
(12) Patent Application Publication
(10) Pub. No.: US 2014/0159470 A1
(43) Pub. Date: Jun. 12, 2014

(54) Vehicle braking system having at least one hydraulic brake circuit

(71) Applicants: Alexander BAREISS, Immenstadt (DE); Andreas Weh, Sulzberg (DE)

(72) Inventors: Alexander BAREISS, Immenstadt (DE); Andreas Weh, Sulzberg (DE)

(21) Appl. No.: 14/101,610

(22) Filed: Dec. 10, 2013

(30) Foreign Application Priority Data
Dec. 12, 2012 (DE) 10 2012 222 957.4
Jan. 13, 2013 (DE) 10 2013 201 577.1

(51) Int. Cl. B60T 13/14

(52) U.S. Cl. CPC B60T 13/141
USPC 303/10

(57) ABSTRACT

A vehicle braking system having a hydraulic brake circuit has a triggerable delivery pump and has an accumulator having an adjustable wall which is acted upon by a spring force in the flow path between an outlet valve of a wheel brake unit and the delivery pump. The adjustable wall is in an intermediate position in the unloaded starting condition.

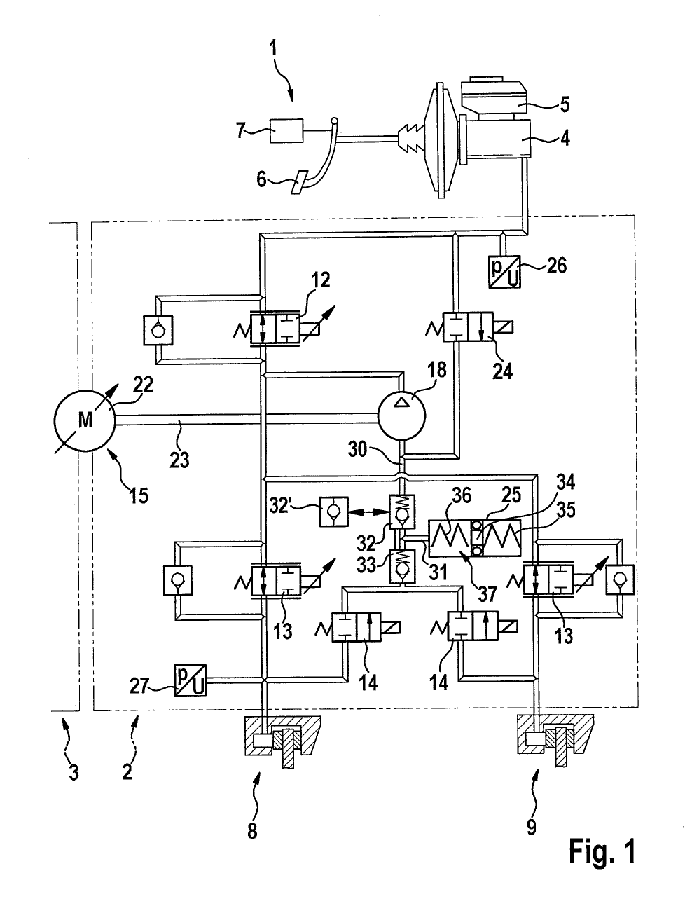

### RELATED APPLICATION INFORMATION

The present application claims priority to and the benefit of German patent application no. 10 2012 222 957.4, which was filed in Germany on December 12, 2012, and of German patent application no. 10 2013 201 577.1, which was filed in Germany on Jan. 31, 2013, the disclosures of each of which are incorporated herein by reference.

### FIELD OF THE INVENTION

The present invention relates to a vehicle braking system having at least one hydraulic brake circuit.

### BACKGROUND INFORMATION

DE 10 2007 020 503 A1 describes a hydraulic vehicle braking system having two brake circuits connected to a shared main brake cylinder. Two wheel brake units are situated on the vehicle wheels in each brake circuit, the brake pressure in the brake circuits being regulated via adjustable valves. The vehicle braking system also has a hydraulic pump unit having one pump per brake circuit and a shared electric pump motor operating both pumps. Driver assistance systems, for example, vehicle dynamics control systems, such as an electronic stability program, may be supported via the hydraulic pump unit. Furthermore, a hydraulic accumulator which is used for intermediate storage of the hydraulic fluid during traction control is integrated into each brake circuit.

### SUMMARY OF THE INVENTION

An object of the present invention is to provide a hydraulic vehicle braking system using simple measures, in such a way that a rapid pressure buildup is ensured.

This object is achieved according to the present invention with the features described herein. The further descriptions herein provide advantageous refinements.

The vehicle braking system according to the present invention is used in motor vehicles or commercial vehicles and has at least one hydraulic brake circuit, which may be two hydraulic brake circuits, via which the wheel brake units are to be supplied with hydraulic brake pressure. Two wheel brake units may be provided on different vehicle wheels for each brake circuit. A triggerable delivery pump is assigned to each brake circuit to be able to modulate the hydraulic brake pressure, so that brake boosting or a vehicle dynamics control system, such as an electronic stability program (ESP), for example, may be implemented. The triggerable delivery pump may be operated via an electric pump motor. One delivery pump is advantageously provided for each brake circuit, multiple delivery pumps being drivable by one shared electric pump motor, if necessary.

To ensure a rapid buildup of pressure in the hydraulic fluid in the brake circuit during a brake application, a low-pressure accumulator for intermediate storage of hydraulic fluid is situated in the brake circuit, in the flow path between an outlet valve of the wheel brake unit and the delivery pump. The low-pressure accumulator is capable of supplying hydraulic volume in immediate proximity to the intake area of the delivery pump, so the hydraulic resistance is reduced, which is reflected in a reduced pressure buildup time in the wheel brake unit accordingly. The low-pressure accumulator also has a reduced mechanical resistance when receiving the hydraulic fluid, so that the low-pressure accumulator may also be filled with a low hydraulic pressure accordingly.

The low-pressure accumulator has an adjustable wall, which is acted upon by spring pressure and is in an intermediate position in the unloaded starting condition, in which no external forces are acting, the accumulator chamber in the low-pressure accumulator having a defined starting volume or initial volume for receiving hydraulic fluid in this intermediate position. The starting volume or initial volume corresponding to the intermediate position of the adjustable wall is between a minimum volume, in which the wall is in a corresponding minimal position, and a maximal volume in which the wall is in a maximal position.

Hydraulic fluid may flow without overcoming any mechanical resistance into the accumulator chamber since a defined starting volume or initial volume in the accumulator chamber is already given in the starting condition due to the position of the wall in the intermediate position. Only after the starting volume has been filled with hydraulic fluid must the wall be adjusted until reaching the maximal position against the resistance of the spring element, which holds the wall in the intermediate position. The required pressure of the increasing spring force increases here accordingly.

It is fundamentally sufficient that the adjustable wall is acted upon by the force applied by precisely one spring element and is held in the intermediate position in the unloaded starting condition. The spring element may thus exert a tensile force as well as a compressive force on the adjustable wall. According to an advantageous embodiment, however, it is provided that the adjustable wall is acted upon by the force applied by two opposing spring elements, so that the application of a force and an adjustment of the wall in the direction of the starting position may be ensured even for a long operating period. The two spring elements are configured as tension springs, compression springs or tension/compression springs.

According to another advantageous embodiment, a first nonreturn valve, which is blocking in the direction of the outlet valve, is situated in the flow path between the outlet valve and the delivery pump. This first nonreturn valve may be equipped with a spring element, which applies force to the valve member in the direction of the blocking position, so that the valve member must be raised against the force of the spring element to open the nonreturn valve. In another embodiment, it may be sufficient to provide a nonreturn valve without a spring element. The first nonreturn valve is advantageously situated between a line branch to the low-pressure accumulator and the delivery pump.

According to another advantageous embodiment, a second nonreturn valve is situated in the flow path between the outlet valve and the delivery pump, this nonreturn valve being placed closer to the outlet valve in relation to the first nonreturn valve. The second nonreturn valve blocks in the direction of the outlet valve. This second nonreturn valve may be situated in the line section between the outlet valve and the line branch to the low-pressure accumulator.

By providing two nonreturn valves upstream and downstream from the line branch to the low-pressure accumulator, various advantageous modes of operation for filling and emptying the low-pressure accumulator may be implemented. It is thus possible in particular to open the outlet valve during a brake application, which is carried out with a limited pressure buildup, i.e., partial braking, whereby the accumulator is filled with hydraulic fluid. Since a maximum pressure buildup is not necessary in partial braking, the minor reduction in pressure due to filling of the accumulator may be accepted or compensated by a slightly increased brake application. This ensures that the accumulator is also filled again regularly after emptying the accumulator, for example, during active pressure buildup during activation by a driver assistance system.

In the case of a driver assistance system, for example, an antilock braking system (ABS) or an electronic stability program (ESP), the brake pressure buildup is modulated in an independent manner. For example, the outlet valve may be opened for carrying out the ABS function, whereupon a pressure is initially reduced and fluid is conveyed into the accumulator. During triggering and activation of the delivery pump, the hydraulic fluid is conveyed out of the accumulator through a switchover valve into the main cylinder of the vehicle braking system. When the outlet valve is open, the nonreturn valve situated directly at the outlet valve prevents an underpressure in the wheel brake unit.

According to another advantageous embodiment, it is provided that the accumulator chamber be evacuated at regular intervals for preventing the outgassing of hydraulic fluid, and then fluid volume is conveyed out of the wheel brake unit back into the accumulator chamber through opening of the outlet valve when the delivery pump is activated. This operation is carried out regularly, in particular after starting the drive engine of the vehicle.

Additional advantages and advantageous embodiments may be derived from the additional description herein.

### BRIEF DESCRIPTION OF THE DRAWING

The FIGURE shows a hydraulic circuit diagram of a vehicle braking system.

### DETAILED DESCRIPTION

The hydraulic braking system in a braking system 1, illustrated in the hydraulic circuit diagram in the FIGURE, has a front-axle brake circuit 2 and a rear-axle brake circuit 3, which is merely suggested, for supplying hydraulic brake fluid to wheel brake units 8 and 9 on the front wheels and on the rear wheels. Fundamentally, braking systems in which the brake circuit allocation is diagonal may also be considered, so that one wheel brake device is provided per brake circuit on a front wheel and another on a rear wheel. Rear-axle brake circuit 3 is configured like front-axle brake circuit 2.

The two brake circuits 2, 3 are connected to a shared main brake cylinder 4, which is supplied with brake fluid via a brake fluid reservoir 5. Main brake cylinder 4 is activated by the driver via brake pedal 6, and the pedal travel exerted by the driver is measured via a pedal travel sensor 7.

A switchover valve 12, which is situated in the flow path between main brake cylinder 4 and corresponding wheel brake units 8 and 9, is situated in brake circuit 2. Switchover valve 12 is open in its basic currentless position. A nonreturn valve, which is switched in parallel and through which the flow may pass in the direction of the corresponding wheel brake units, is assigned to switchover valve 12.

Inlet valves 13, which are also opened when currentless and to which nonreturn valves are assigned, through which the flow may pass in the opposite direction, i.e., from the wheel brake units in the direction of main brake cylinder 4 are also situated between switchover valve 12 and corresponding wheel brake units 8, 9.

An outlet valve 14, which is closed when currentless, is assigned to each wheel brake unit 8, 9. Outlet valves 14 are each connected to the intake side of a pump unit 15 having a delivery pump 18 in brake circuit 2. An electric drive motor or pump motor 22, which activates delivery pump 18 via a shaft 23, is assigned to the pump unit. The pressure side of delivery pump 18 is connected to a line section between switchover valve 12 and two inlet valves 13.

The intake side of delivery pump 18 is connected to a high-pressure switchover valve 24, which is itself connected hydraulically to main brake cylinder 4. In the event of an ESP intervention, high-pressure switchover valve 24, which is closed in the currentless state, may be opened for a rapid buildup of brake pressure, so that delivery pump 18 draws in hydraulic fluid directly from main brake cylinder 4. This brake pressure buildup may be carried out independently of the operation of the braking system by the driver. Pump unit 15 together with delivery pump 18, electric pump motor 22 and shaft 23 belongs to a driver assistance system and is an integral part of an electronic stability program (ESP).

For the pressure measurement, a first pressure sensor 26 in brake circuit 2 is situated adjacent to main brake cylinder 4, and a second pressure sensor 27 is situated on wheel brake unit 8.

A low-pressure accumulator 25, which is used for intermediate storage of brake fluid, which is discharged from wheel brake devices 8, 9 through outlet valves 14 during an ESP intervention is situated between outlet valves 14 and the intake side of delivery pump 18 in brake circuit 2. Accumulator 25 is also part of the electronic stability program (ESP). Accumulator 25 is situated in a line section 31 which branches off from a connecting line 30 between outlet valves 14 and the intake side of delivery pump 18.

A first nonreturn valve 32 and a second nonreturn valve 33 are assigned to accumulator 25, both of them being situated in connecting line 30 and blocking in the direction of outlet valves 14 and opening in the direction of the intake side of delivery pump 18.

First nonreturn valve 32 is situated between line section 31 to accumulator 25 and delivery pump 18; second nonreturn valve 33 is situated in connecting line 30 between outlet valves 14 and branching line section 31 to accumulator 25. Both nonreturn valves 32, 33 are acted upon, moving them into their blocking position by the force of a spring element. However, first nonreturn valve 32 may, if necessary, also be implemented without a nonreturn spring element in an alternative embodiment, represented by reference numeral 32′.

Low-pressure accumulator 25 has an accumulator chamber 37, which is used for accommodating hydraulic fluid, which may be introduced into and removed from accumulator chamber 37 via connecting line 30 and line section 31. Accumulator chamber 37 is delimited by a movable adjustable wall 34, which is held by two spring elements 35 and 36 in an intermediate position, which wall 34 assumes in the starting condition or initial condition, in which no external forces are acting on the wall. Wall 34 is to be shifted, depending on the pressure conditions between a minimal position, which reduces the chamber volume in accumulator chamber 37, and a maximal position, which increases the chamber volume. In the minimal position, the volume of accumulator chamber 37 may be reduced to zero, if necessary.

Depending on the switch condition of the valves in the brake circuit and activation of delivery pump 18, hydraulic fluid may be introduced into and discharged from accumulator chamber 37. This takes place either as part of a regular brake application, in particular for filling accumulator chamber 37, or during activation of a driver assistance system for modulating the pressure in the hydraulic brake circuit, in particular during activation of an antilock braking system ABS or an electronic stability program ESP. For example, during an active pressure buildup in the braking system, switchover valve 12 may be closed and high-pressure switchover valve 24 may be opened and delivery pump 18 may be activated at the same time. The resulting underpressure on the intake side draws hydraulic fluid out of accumulator chamber 37, thereby reducing the volume in the accumulator chamber. The hydraulic fluid is discharged through open nonreturn valve 32.

If the driver brakes during the active pressure buildup, nonreturn valve 32 closes, so that brake fluid is prevented from returning to accumulator chamber 37 and a soft braking performance is avoided.

According to another advantageous embodiment, during a brake application initiated by a driver, in which there is only a limited buildup of pressure below the maximum pressure, accumulator 25 may again be filled with hydraulic fluid. This takes place during the pressure relief operation by the driver, i.e., in retracting the brake pedal operation, which may be detected by pressure sensor 26, which is assigned to main brake cylinder 4. In this phase, outlet valves 14 open and accumulator chamber 37 is filled with hydraulic fluid again. Outlet valves 14 may then be closed afterward.

According to another advantageous embodiment, accumulator chamber 37 is evacuated regularly to prevent hydraulic fluid from outgassing in that delivery pump 18 is activated when outlet valves 14 are initially closed. After evacuation, accumulator chamber 37 is filled again by opening outlet valves 14. This operation may be carried out regularly, in particular after each start of the drive engine of the vehicle.

What is claimed is:

1. A vehicle braking system, comprising:
at least one hydraulic brake circuit via which at least one wheel brake unit is to be supplied with brake pressure;
a triggerable delivery pump; and
an accumulator having an accumulator chamber for accommodating hydraulic fluid being situated in the flow path between an outlet valve of the wheel brake unit and the delivery pump;
wherein the accumulator is configured as a low-pressure accumulator in which an adjustable wall to which a spring force is applied is in an intermediate position in which the accumulator chamber has a defined starting volume when in the unloaded initial state, the wall being adjustable between a minimal position, which reduces the chamber volume, and a maximal position, which increases the chamber volume.

2. The vehicle braking system of claim 1, wherein the adjustable wall in the accumulator is held by two spring elements in a central position in the starting condition.

3. The vehicle braking system of claim 1, wherein a first nonreturn valve, which blocks in the direction of the outlet valve, is situated in the flow path between the outlet valve and the delivery pump.

4. The vehicle braking system of claim 4, wherein the first nonreturn valve is configured without a spring element.

5. The vehicle braking system of claim 3, wherein the first nonreturn valve is situated between a line branch to the accumulator and the delivery pump.

6. The vehicle braking system of claim 3, wherein a second nonreturn valve, which blocks in the direction of the outlet valve and is placed closer to the outlet valve in relation to the first nonreturn valve, is situated in the flow path between the outlet valve and the delivery pump.

7. The vehicle braking system of claim 6, wherein the second nonreturn valve is situated between the outlet valve and the line branch to the accumulator.

8. A method for operating a vehicle braking system, the method comprising:
opening an outlet valve for filling an accumulator with hydraulic fluid during a brake application of the vehicle braking system;
wherein the vehicle braking system includes:
at least one hydraulic brake circuit via which at least one wheel brake unit is to be supplied with brake pressure;
a triggerable delivery pump;
the accumulator having an accumulator chamber for accommodating the hydraulic fluid being situated in the flow path between an outlet valve of the wheel brake unit and the delivery pump;
wherein the accumulator is configured as a low-pressure accumulator in which an adjustable wall to which a spring force is applied is in an intermediate position in which the accumulator chamber has a defined starting volume when in the unloaded initial state, the wall being adjustable between a minimal position, which reduces the chamber volume, and a maximal position, which increases the chamber volume.

9. The method of claim 8, wherein the accumulator is filled with hydraulic fluid during a brake application under a limited pressure buildup.

10. The method of claim 8, wherein to prevent outgassing of hydraulic fluid, the accumulator chamber in the accumulator is evacuated by activating the delivery pump and the accumulator chamber is subsequently filled again by opening the outlet valve.

11. The method of claim 8, wherein the evacuation and subsequent filling of the accumulator chamber are carried out after starting the drive engine of the vehicle.
